(19) United States
(12) Patent Application Publication
(10) Pub. No.: US 2025/0226530 A1
(43) Pub. Date: Jul. 10, 2025

(54) COATED SEPARATOR WITH CERAMIC MICRO-WIRES

(71) Applicant: Celgard, LLC, Charlotte, NC (US)

(72) Inventors: Wenbin Yin, Charlotte, NC (US); Zhengming Zhang, Rock Hill, SC (US)

(21) Appl. No.: 18/849,514

(22) PCT Filed: Mar. 20, 2023
(86) PCT No.: PCT/US2023/015647

§ 371 Date: Sep. 22, 2024

Related U.S. Application Data
(60) Provisional application No. 63/323,087, filed on Mar. 24, 2022.

(51) Int. Cl. H01M 50/434; H01M 50/417; H01M 50/451

(52) U.S. Cl. CPC H01M 50/434; H01M 50/417; H01M 50/451

(57) ABSTRACT

A ceramic-coated battery separator exhibiting improved safety has the following structure: a battery separator; and a ceramic coating that comprises ceramic micro-wires. The ceramic coating may comprise ceramic micro-wires as the only ceramic material, or may comprise a mixture of ceramic micro-wires and ceramic particles.

### RELATED APPLICATION DATA

This Application is a 371 U.S. Application which claims priority to PCT Application No. PCT/US2023/015647, filed Mar. 20, 2023, which claims priority to U.S. Provisional Application No. 63/323,087, filed Mar. 24, 2022, and is incorporated herein in its entirety.

### FIELD

This application is directed a ceramic-coated battery separator with a ceramic coating that comprises ceramic micro-wires. The ceramic coating may be provided on one or both sides of the battery separator. The ceramic-coated battery separator described herein exhibits improved safety compared to prior ceramic-coated battery separators.

### BACKGROUND

Celgard was the first to provide a ceramic-coated separator, which dramatically increased the safety of lithium ion batteries. See Celgard®'s seminal patent U.S. Pat. No. 6,432,586, now RE 47,520.

Battery separators are subjected to rigorous safety testing, including the puncture strength test. This test evaluates the ease with which a separator is punctured, and the results of said puncture. Separators with great resistance to being punctured are preferred. Additionally, when punctured, it is preferable that the opening made is small. A small opening minimizes the likelihood that a dendrite will pass through the separator via the opening. Thus, there is a desire for the following: 1) battery separators with high puncture strength, and 2) when the separator is punctured, smaller openings are formed.

### SUMMARY

Described herein is a ceramic-coated battery separator that exhibits improved safety properties compared to prior ceramic-coated battery separators. When punctured, the resulting holes in the ceramic-coated battery separators described herein are smaller than those formed when prior ceramic-coated battery separators are punctured. These smaller holes, minimize the likelihood that a dendrite will pass through the separator via the opening. If this happens, short-circuiting, thermal runaway, and/or explosion may result.

In one aspect, it is described a ceramic-coated battery separator comprising the following: a separator; and a ceramic coating on at least one side of the battery separator, wherein the ceramic coating comprises ceramic micro-wires. In some embodiments, the ceramic coating may comprise a mixture of ceramic particles and ceramic micro-wires. The ratio of particles to micro-wires in the coating may be from 1:99 to 99:1. In some embodiments, the ratio may be 50:50. In some embodiments, the ceramic micro-wires are the only ceramic material in the ceramic coating, i.e., 100% ceramic micro-wires.

The ceramic micro-wires may have a length of from 1 micron to 20 microns or more, or from 1 micron to 10 microns or more. The ceramic micro-wires comprise one or more selected from alumina, titania, zirconia, boehmite, glass, silica, and combinations thereof.

When added, the ceramic particles may comprise one or more selected from alumina, titania, zirconia, boehmite, glass, silica, and combinations thereof. The particles have an average particle size from 1 to 10 microns.

In some preferred embodiments, the ceramic micro-wires, the ceramic particles, or both the ceramic micro-wires and the ceramic particles are not electrically conductive.

In some embodiments, the ceramic coating is formed using an aqueous coating slurry.

The separator of the ceramic-coated separator may be a polyolefin separator or a polyolefin separator formed by a dry-stretch process.

### BRIEF DESCRIPTION OF FIGURES

FIG. 1 is an SEM of a ceramic-coated separator according to some embodiments described herein.

FIG. 2 is an SEM of a ceramic-coated separator according to some embodiments described herein.

FIG. 3 is an SEM of a ceramic-coated separator according to some embodiments described herein.

FIG. 4 is an SEM of a ceramic-coated separator according to some embodiments described herein.

FIG. 5 is an SEM of a ceramic-coated separator according to some embodiments described herein.

FIG. 6 is an SEM of a ceramic-coated separator according to some embodiments described herein.

FIG. 7 is a table including data according to some embodiments described herein.

FIG. 8 is a table including data according to some embodiments described herein.

FIG. 9 is an image of coated-separators described herein after the puncture strength test showing less splitting and smaller holes in the inventive ceramic-coated separators.

FIG. 10 is an optical analysis on the coated side of ceramic-coated separators described herein showing smaller holes in the inventive ceramic-coated separators.

### DESCRIPTION

The ceramic-coated separator described herein provides improved safety compared to past ceramic coatings that do not include any ceramic micro-wires that are not electrically conductive. It is desirable that the separator is completely electrically isolated. If the separator is electrically conductive, self-discharge will happen.

The ceramic-coated separator described herein comprises, consists of, or consists essentially of: 1) a battery separator; and 2) a ceramic coating on one or both sides of the battery separator. The thickness of the coated battery separator may be from 2 to 30 microns, from 2 to 25 microns, from 2 to 20 microns, from 2 to 15 microns, from 2 to 10 microns, or from 2 to 5 microns.

### Battery Separator

The type of battery separator is not so limited so long as it functions. Some typical properties of a functional battery separator include being electrically insulative and ionically conductive.

The material of the battery separator is also not so limited, and any suitable thermoplastic resin may be used. In some preferred embodiments, the thermoplastic resin may be a polyolefin homopolymer, copolymer, terpolymer, or multimer. A polyethylene homopolymer, copolymer, terpolymer, or multimer may be used. A polypropylene homopolymer, copolymer, terpolymer, or multimer may be used. A blend of two or more suitable thermoplastic resins may also be used. In some preferred embodiments, the battery separator may be formed by a dry process that does not utilize oils, solvents, plasticizers, particles, or other additives to form pores. For example, a dry-stretch process, including the Celgard® dry-stretch process, which involves at least an extrusion step, an annealing step, and a stretching step, may be used. The separator may also be formed using a wet process, which uses solvents, plasticizers, or oils to form pores. The separator may also be formed using particle-stretch process. The structure of the membranes formed by these different methods are different.

In some embodiments, the battery separator used herein is one that is prone to splitting or has splittiness issues. The ceramic coating described herein may reduce these substantially.

The battery separator may have a thickness from 1 micron to 25 microns, from 1 to 20 microns, from 1 to 15 microns, from 1 to 10 microns, or from 1 to 5 microns.

Ceramic Coating with Micro-Wires

The ceramic coating has a thickness of 0.5 to 5 microns, 0.5 to 4 microns, 0.5 to 3 microns, 0.5 to 2 microns, or 0.5 to 1 microns.

The ceramic coating comprises ceramic material and optionally a binder, other additives, or binder and other additives.

The ceramic materials comprises, consists of, or consists essentially of ceramic micro-wires. In some embodiments, the ceramic material comprises, consists of, or consists essentially of ceramic micro-wires and ceramic particles. In some embodiments the ceramic material may include ceramic micro-wires as the only ceramic material. In embodiments where the ceramic material includes ceramic micro-wires and ceramic particles, the ratio may be 99:1 to 1:99, 5:95 to 95:5, 10:90 to 90:10, 20:80 to 80:20, 30:70 to 70:30, 40:60 to 60:40, or 50:50.

The micro-wires may have a length of 1 to 50 microns, 1 to 40 microns, 1 to 30 microns, 1 to 20 microns, 1 to 15 microns, 1 to 10 microns, or 1 to 5 microns. The diameter may be from 1 to 10 microns, 1 to 9 microns, 1 to 8 microns, 1 to 7 microns, 1 to 6 microns, 1 to 5 microns, 1 to 4 microns, 1 to 3 microns, or 1 to 2 microns.

The ceramic micro-wires may comprise one or more selected from BaSO₄, CaCO₃, BN, alumina, titania, zirconia, boehmite, and combinations thereof.

The ceramic particles may have an average particle size of 1 to 50 microns, 1 to 40 microns, 1 to 30 microns, 1 to 20 microns, 1 to 15 microns, 1 to 10 microns, or 1 to 5 microns.

The ceramic micro-wires may comprise one or more selected from BaSO₄, CaCO₃, BN, alumina, titania, zirconia, boehmite, glass, silica, and combinations thereof.

When a binder is added, the binder is not so limited, and most polymeric binders will suffice. For example, the binder could be an acrylic binder, PVDF binder, PVA binder, PNVA binder, etc.

A ratio of binder to ceramic material in the coating may be 1:99, 2:98, 3:97, 4:96, 5:95, 6:94, 7:93, 8:92, 9:91, 10:90, 20:80, 30:70, 40:60, or the like, so long as the amount of ceramic material is greater than the amount of binder.

### Examples

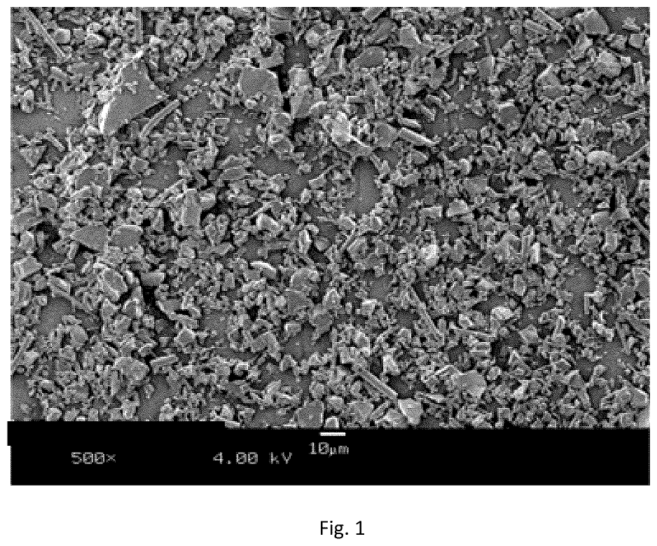

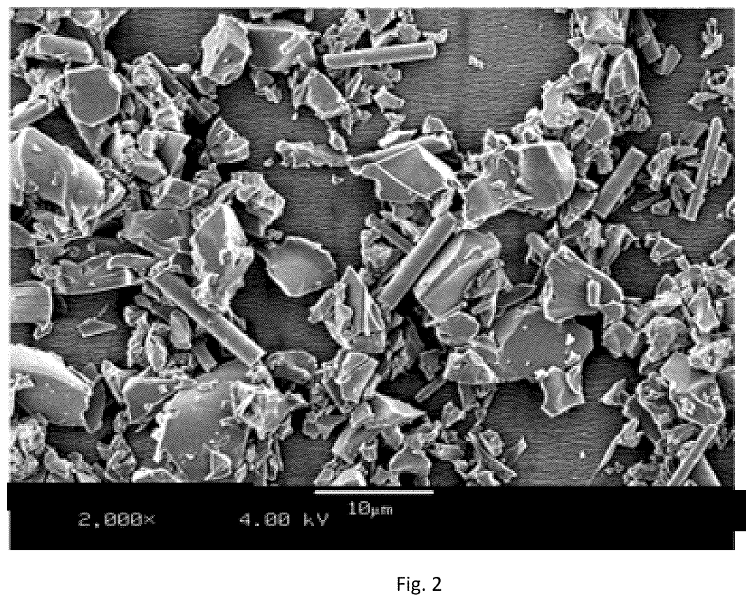

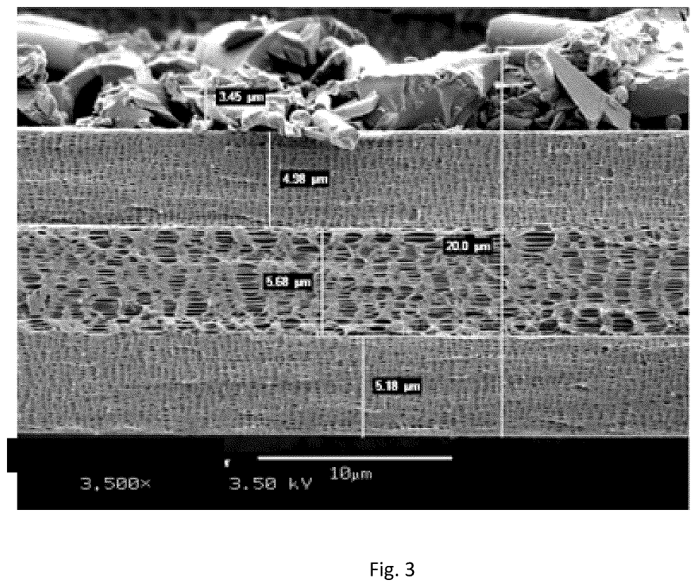

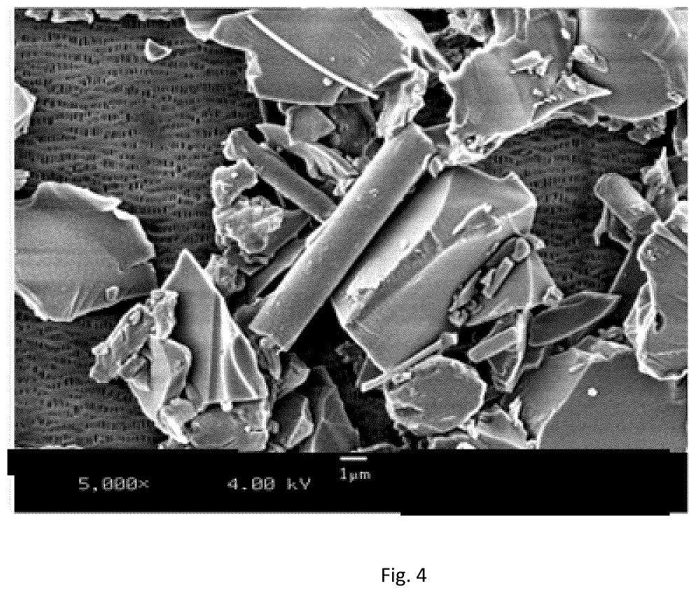

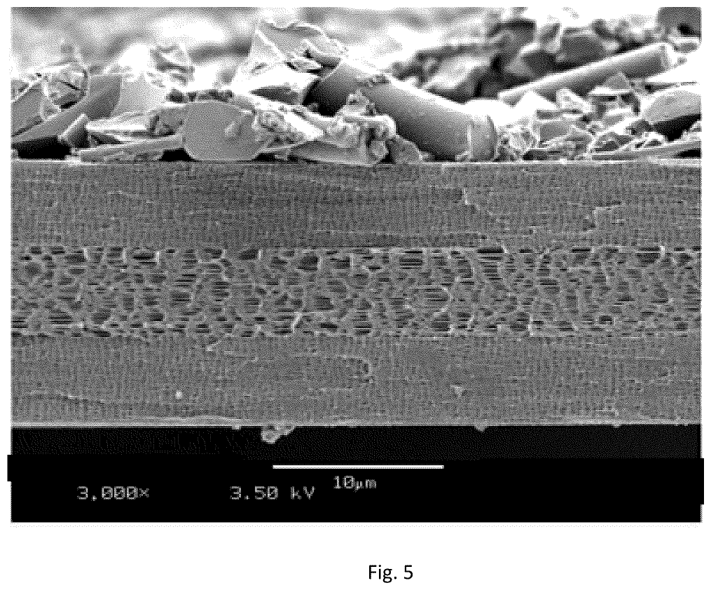

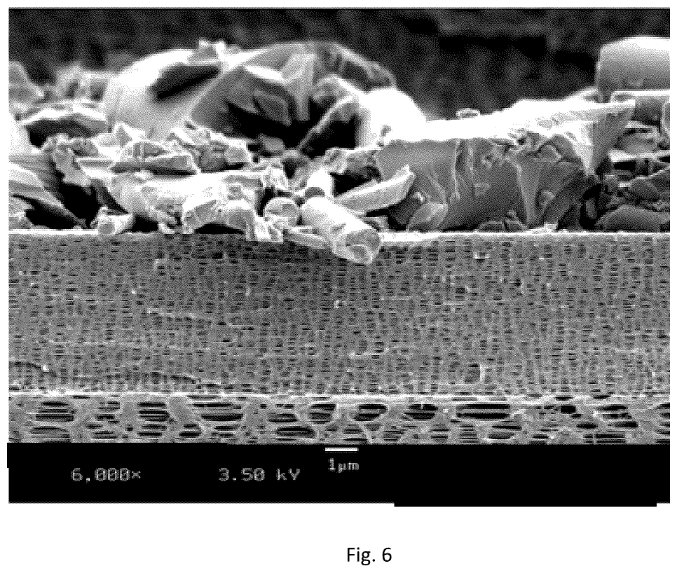

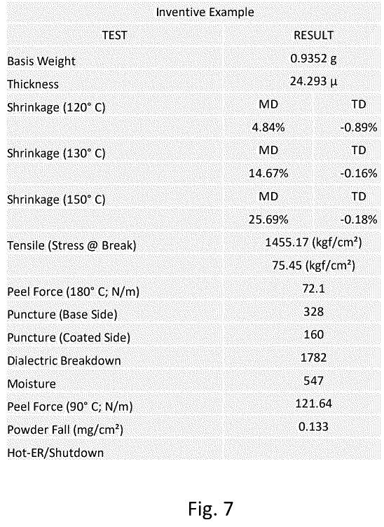

An Inventive ceramic-coated separator was formed by providing a ceramic coating on a tri-layer polyolefin separator that was formed by a dry-stretch process. The ceramic coating was formed to a thickness of about 3.5 microns and contains alumina ceramic micro-wires. The ceramic coating also includes alumina ceramic particles. SEMs of the inventive ceramic-coated separator are found in FIGS. 1, 2, 3, 4, 5, 6, and 7, showing different views. For example, FIG. 1, FIG. 2, and FIG. 4 show a top-view of the ceramic coating, and FIG. 3, FIG. 5 and FIG. 6 show a cross-sectional view of the ceramic-coated separator. FIG. 7 shows tests performed on the inventive ceramic-coated separator, and the results.

A comparative ceramic-coated separator that is like the inventive example, except that no ceramic micro-wires are added to the coating, is also formed.

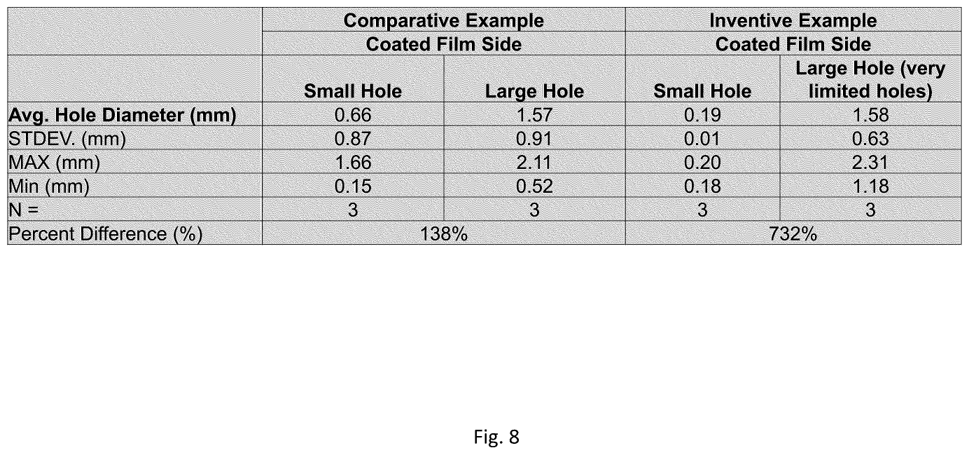

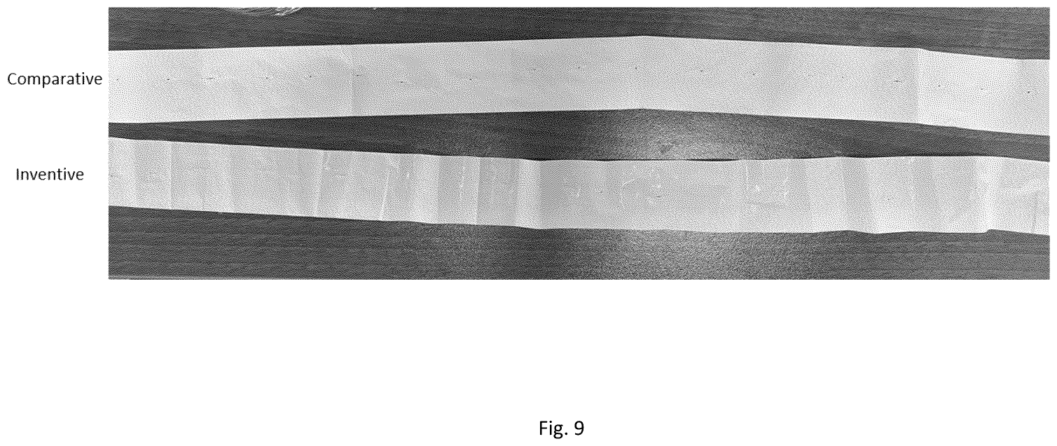

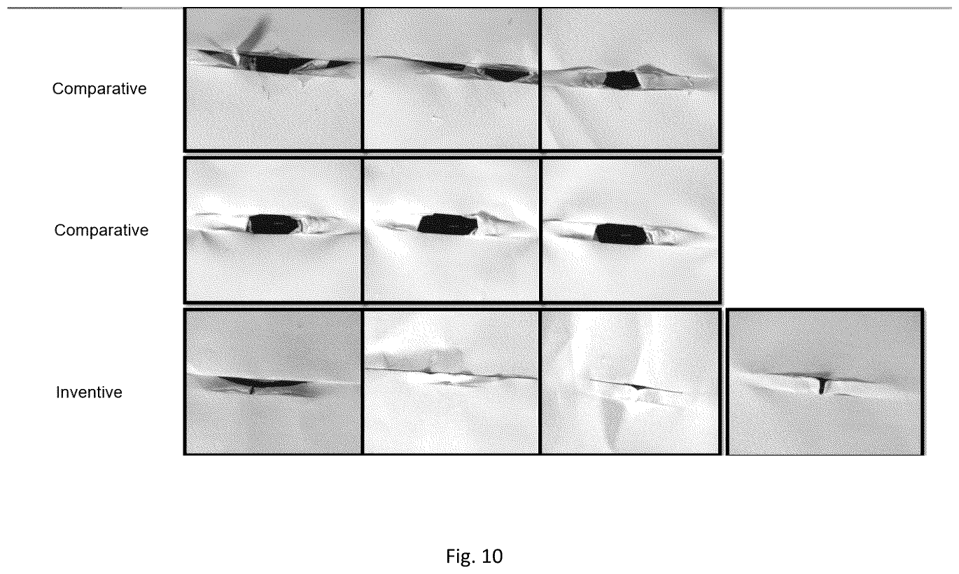

A puncture test was performed on both the inventive and the comparative examples. Data from this test is shown in FIG. 8, FIG. 9, and FIG. 10. The puncture test was performed as follows: an Instron testing device outfitted with a needle is applied to a piece of separator that has no backing or support. The force required to penetrate the film is recorded. This is a common test for battery makers.

1. A ceramic-coated separator, comprising:
a separator; and
a ceramic coating on at least one side of the battery separator, wherein the ceramic coating comprises ceramic micro-wires.

2. The ceramic-coated separator of claim 1, wherein the ceramic coating comprises a mixture of ceramic particles and ceramic micro-wires.

3. The ceramic-coated separator of claim 2, wherein a ratio of particles to micro-wires is 1:99 to 99:1.

4. The ceramic-coated separator of claim 3, wherein the ratio is 50:50.

5. The ceramic coating of claim 1, wherein the ceramic micro-wires are the only ceramic material in the ceramic coating.

6. The ceramic-coated separator of claim 1, wherein the ceramic micro-wires have a length of 1 micron to 20 microns or more.

7. The ceramic-coated separator of claim 1, wherein the ceramic micro-wires have a length of 1 micron to 10 microns or more.

8. The ceramic-coated separator of claim 1, wherein the ceramic micro-wires comprise one or more selected from BaSO₄, CaCO₃, BN, alumina, titania, zirconia, boehmite, glass, silica, and combinations thereof.

9. The ceramic-coated separator of claim 8, wherein the ceramic micro-wires comprise alumina.

10. The ceramic-coated separator of claim 8, wherein the ceramic micro-wires comprise titania.

11. The ceramic-coated separator of claim 8, wherein the ceramic micro-wires comprise zirconia.

12. The ceramic-coated separator of claim 8, wherein the ceramic micro-wires comprise boehmite

13. The ceramic-coated separator of claim 2, wherein the ceramic micro-wires comprise one or more selected from BaSO₄, CaCO₃, BN, alumina, titania, zirconia, boehmite, glass, silica, and combinations thereof.

14. The ceramic-coated separator of claim 2, wherein the ceramic particles comprise one or more selected from BaSO₄, CaCO₃, BN, alumina, titania, zirconia, boehmite, glass, silica, and combinations thereof.

15. The ceramic-coated separator of claim 2, wherein the particles have an average particle size from 0.1 to 10 microns.

16. The ceramic-coated separator of claim 1, wherein the ceramic coating is formed using an aqueous coating slurry.

17. The ceramic-coated separator of claim 1, wherein the separator is a polyolefin separator.

18. The ceramic-coated separator of claim 1, wherein the separator is a polyolefin separator formed by a dry-stretch process.

19. The ceramic-coated separator of claim 1, wherein the ceramic micro-wires are not electrically conductive.

20. The ceramic-coated separator of claim 1, wherein the ceramic micro-wires and the ceramic particles are not electrically conductive.
